(19) United States
(12) Patent Application Publication
(10) Pub. No.: US 2024/0256499 A1
(43) Pub. Date: Aug. 1, 2024

(54) FETCHING RENDERABLE PARTS OF CONTENT ITEMS IN BULK

(71) Applicant: Intercom, Inc., San Francisco, CA (US)

(72) Inventors: Eoin Nolan, Dublin (IE); Richard Livsey, Dublin (IE); Jack Ryan, Dublin (IE)

(21) Appl. No.: 18/427,592

(22) Filed: Jan. 30, 2024

Related U.S. Application Data
(60) Provisional application No. 63/442,403, filed on Jan. 31, 2023.

(51) Int. Cl. G06F 16/21; G06F 16/2457

(52) U.S. Cl. CPC G06F 16/211; G06F 16/24575

(57) ABSTRACT

A system and method of fetching renderable parts of content items in bulk. The method includes generating, by a processing device, a database schema to store an initial part of a conversation and a plurality of replies of the conversation, the initial part is sourced from a data source and the plurality of replies of the conversation is sourced from a plurality of other data sources. The method includes receiving, from a client device, a request to provide the conversation. The method includes fetching the database schema from a single data source. The method includes transmitting the database schema to the client device for displaying, in an application executing on the client device, the initial part of the conversation and the plurality of replies of the conversation.

### RELATED APPLICATIONS

This application claims benefit of provisional U.S. Patent Application No. 63/442,403 filed on Jan. 31, 2023, which is herein incorporated by reference in its entirety.

### TECHNICAL FIELD

The present disclosure relates generally to software technology, and more particularly, to systems and methods of fetching renderable parts of content items in bulk.

### BACKGROUND

An email client, email reader or, more formally, message user agent (MUA) or mail user agent is a computer program used to access and manage a user's email. A web application which provides message management, composition, and reception functions may act as a web email client, and a piece of computer hardware or software whose primary or most visible role is to work as an email client may also use the term.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example environment for managing communications with users and potential users of a communication system, according to some embodiments;

FIG. 2 is a block diagram of an example model that generates initial parts of a conversation using a conventional approach, according to some embodiments;

FIG. 3 is a block diagram of a conversation using a conventional approach, according to some embodiments;

FIG. 4 is a block diagram for displaying a conversation using the conventional approach, according to some embodiments;

FIG. 5 is a block diagram of an example model that generates initial parts of a conversation using a renderable part approach, according to some embodiments;

FIG. 6 is a block diagram of a conversation using the renderable part approach, according to some embodiments;

FIG. 7 is a table depicting a RenderablePart data model for the renderable part approach, according to some embodiments;

FIG. 8 is a table depicting a RenderablePart data model for the renderable part approach, according to some embodiments;

FIG. 9 is a block diagram of displaying a conversation with a conversation summary list using a conventional approach, according to some embodiments;

FIG. 10 is a block diagram of displaying a conversation with a conversation summary list using a last part reference approach, according to some embodiments;

FIG. 11 is a table depicting a LastPartReference data model for the last part reference approach, according to some embodiments;

FIG. 12 is a table depicting a RenderablePart data model for the last part reference approach, according to some embodiments;

FIG. 13 is a block diagram of data loading to display a conversation using a conventional approach, according to some embodiments;

FIG. 14 is a block diagram of the latency to display a conversation using a conventional approach, according to some embodiments;

FIG. 15 is a block diagram of the latency to display a conversation using a bulk fetch approach, according to some embodiments;

FIG. 16A is a block diagram depicting an example of the communication system 102 in FIG. 1, according to some embodiments;

FIG. 16B is a block diagram depicting an example of a customer device in FIG. 1 (or end user device 118 in FIG. 1 or third party system 120 in FIG. 1), according to some embodiments;

FIG. 17 is a flow diagram depicting a method of fetching renderable parts of content items in bulk, according to some embodiments; and

FIG. 18 is a block diagram of an example computing device 1700 that may perform one or more of the operations described herein, in accordance with some embodiments.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements.

As used herein, the term “communication system” may refer to the system and/or program that manages communications between individuals and companies. The term “customer” may refer to a company or organization utilizing the communication system to manage relationships with its end users or potential end users (leads). The term “user” and “end user” may refer to a user (sometimes referred to as, “lead”) of an end user device that is interfacing with the customer through the communication system. The term “company” may refer to an organization or business that includes a group of users. The term “engineer” or “developer” may refer to staff managing or programing the communication system.

A conversation is made up of many parts, each one representing a message sent from an end user into the system of an organization, or from the system to the end user. When displaying a conversation in a message application according to a conventional approach, the first (initial) part is stored and retrieved very differently from the rest of the comments in the conversation. The system might support broadcasting messages to many different end users, and for these conversations the system would store one initial part for all conversations. The initial part supports templated text, which is substituted with user specific information when it is displayed.

Messages can also be versioned so, depending on when the message was sent, different conversations may have a different version of the content. In order to display this conversation, the system must fetch the correct version and also any associated data specific to that conversation, such as the user data at that point in time, in order to display the right thing to the user. The benefits of the conventional approach for displaying a conversation are that for messages broadcast to many users, the system only stores one record in a database (e.g., a data source), which makes it more efficient both in terms of storage and speed at the time of broadcast.

However, this conventional approach is expensive when it comes to displaying the conversation to the support agent in the message inbox as the system pays the cost (e.g., additional delay, excesses use of computing and networking resources, write cost on the shared databases, etc.) of building the representation every time, and conversations are read many times more often than they are sent. This conventional approach also requires the system to fetch data from multiple locations in order to build the whole conversation stream.

Aspects of the present disclosure address the above-noted and other deficiencies by fetching renderable parts of content items in bulk. As discussed in greater detail below, the embodiments of the present disclosure create a new database table for “renderable parts” which contain all the parts for a conversation and do not treat the initial part of the conversation any differently than any of the other parts of the conversation. These are stored alongside the existing data, so it is purely additive and other parts of the system need not be aware of the changes. This means that fetching the contents of a single conversation is now cheap as the system no longer needs to fetch the initial part separately from the rest of the conversation, and any templated data from the initial part is stored as it needs to be sent so it does not require any additional work to be displayed. Advantageously, the embodiments of the present disclosure are able to perform fewer queries and perform them in parallel; thereby reducing latency, as well as, reducing (or eliminating) network congestion.

### 1. Environment for Managing Links and Tracking User Interactions

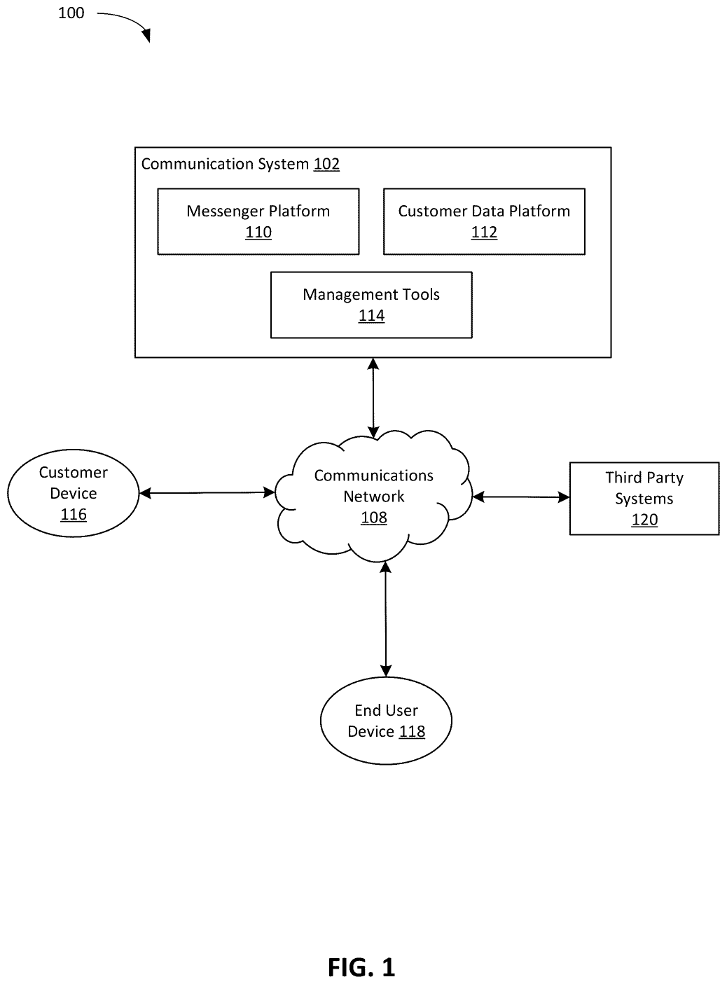

FIG. 1 is a block diagram depicting an example environment for managing communications with users and potential users of a communication system, according to some embodiments. As shown, the environment 100 includes a communication system 102 that is interconnected with a customer device 116 (sometimes referred to as, a client device), an end user device 118 (sometimes referred to as, a client device), and third party systems 120 via a communications network 108. The communications network 108 may be the internet, a wide area network (WAN), intranet, or other suitable network. The communication system 102 may be hosted on one or more local servers, may be a cloud-based system, or may be a hybrid system with local servers and in the cloud. The communication system 102 is maintained by engineers which develop management tools 114 that include an interface or editor for clients of the communication system 102 to interface with the communication system 102.

The communication system 102 includes management tools 114 that are developed to allow customers to develop user series or user paths in the form of nodes and edges (e.g., a connection between nodes) that are stored in a customer data platform 112 of the communication system 102. The communication system 102 includes a messenger platform 110 that interacts with end user devices 118 (or customer device 116) in accordance with the user paths stored in the customer data platform 112.

A customer interacts with the communication system 102 by accessing a customer device 116. The customer device 116 may be a general-purpose computer or a mobile device. The customer device 116 allows a customer to access the management tools 114 to develop the user paths stored in the customer data platform 112. For example, the customer device 116 may execute an application using its hardware (e.g., a processor, a memory) to send a request to the communication system 102 for access to a graphical editor, which is an application programming interface (API) stored in the management tools 114. In response to receiving the request, the communication system 102 may send a software package (e.g., executable code, interpreted code, programming instructions, libraries, hooks, data, etc.) to the customer device 116 to cause the customer device 116 to execute the software package using its hardware (e.g., processor, memory). In some embodiments, the application may be a desktop or mobile application, or a web application (e.g., a browser). The customer device 116 may utilize the graphical editor to build the user paths within the graphical editor. The graphical editor may periodically send copies (e.g., snapshots) of the user path as it is being built to the communication system 102, which in turn, stores the user paths to the customer data platform 112. The user paths manage communication of the customer with a user to advance the user through the user paths. The user paths may be developed to increase engagement of a user with the customer via the messenger platform 110.

The messenger platform 110 may interact with a user through an end user device 118 that accesses the communication network 108. The end user device 118 may be a general-purpose computer or mobile device that access the communication network 108 via the internet or a mobile network. The user may interact with the customer via a website of the customer, a messaging service, or interactive chat. In some embodiments, the user paths may allow a customer to interface with users through mobile networks via messaging or direct phone calls. In some embodiments, a customer may develop a user path in which the communication system 102 interfaces with a user device via a non-conversational channel such as email.

The communication system 102 includes programs or workers that place users into the user paths developed by the customers stored in the customer data platform 112. The communication system 102 may monitor progress of the users through the user paths developed by the customer and interact with the customer based on the nodes and edges developed by the customer for each user path. In some embodiments, the communication system 102 may remove users from user paths based on conditions developed by the customer or by the communication system 102.

The communication system 102 and/or the customers may employ third party systems 120 to receive (e.g., retrieve, obtain, acquire), update, or manipulate (e.g., modify, adjust) the customer data platform 112 or user data which is stored in the customer data platform 112. For example, a customer may utilize a third party system 120 to have a client chat directly with a user or may utilize a bot (e.g., a software program that performs automated, repetitive, and/or pre-defined tasks) to interact with a user via chat or messaging.

Although FIG. 1 shows only a select number of computing devices and/or systems (e.g., communication system 102, customer device 116, third party systems 120, and end user device 118), the environment 100 may include any number of computing devices and/or systems that are interconnected in any arrangement to facilitate the exchange of data between the computing devices and/or systems.

Each of the communication system 102, the customer device 116, and the end user device 118 may be configured to perform one or more (or all) of the operations that are described herein.

### 2. Renderable Parts of a Conversation

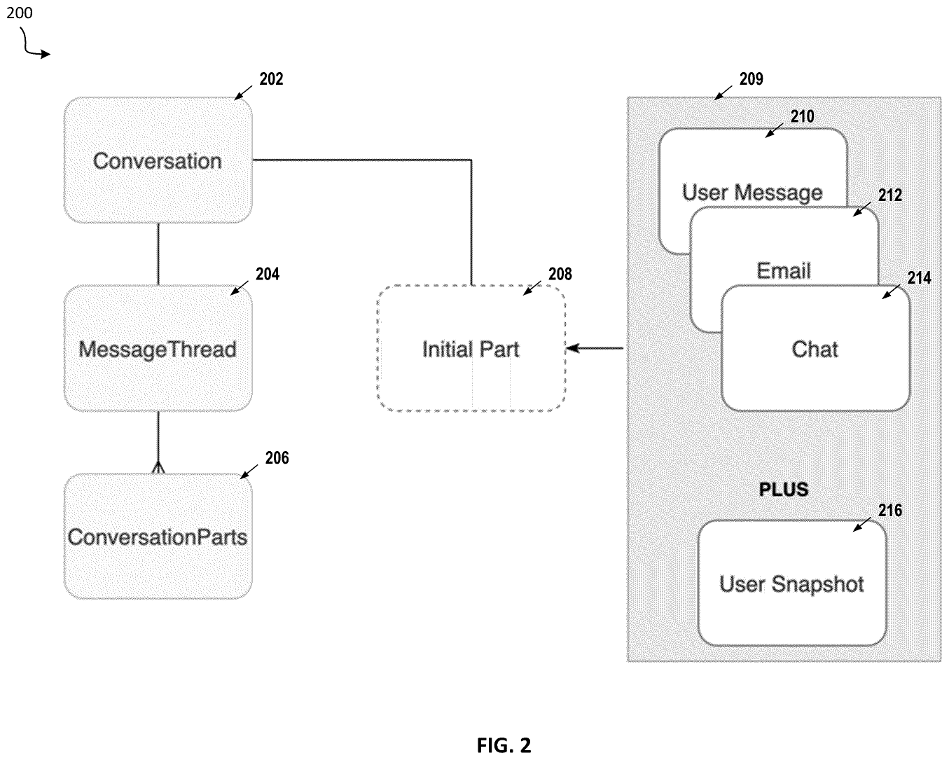

FIG. 2 is a block diagram of an example model that generates initial parts of a conversation using a conventional approach, according to some embodiments. The block diagram includes a conversation 202 (sometimes referred to as, a message), a message thread 204, a conversation parts 206, and an initiator model 209. The initiator model 209 includes a user message 210, an email message 212, a chat message 214, and a user snapshot 216. The initiator model 209 may execute on any of the communication system 102, the customer device 116, and/or the end user device 118. The initiator model may be configured to generate an initial part 208 based on the conversation 202, the message thread 204, and/or the conversation parts 206. In other words, the initiator model may be the entity that started a conversation (e.g., an outbound email). The initial part refers to the first part of a conversation thread (e.g., a message that an end user wrote, or an instance of a bulk outbound message like an email).

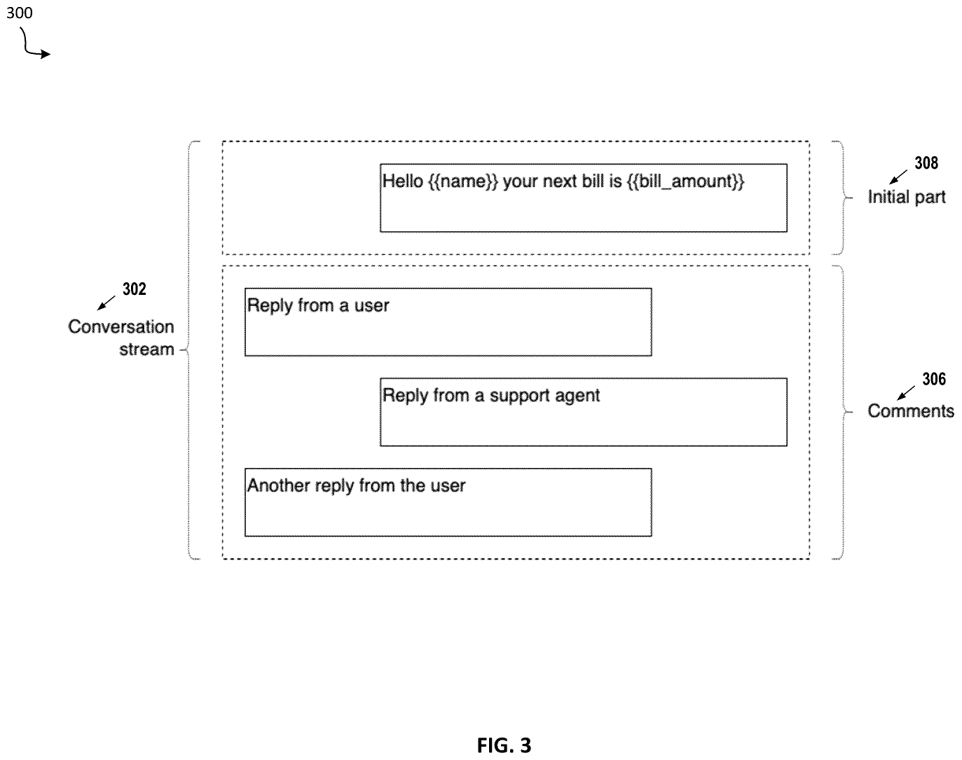

FIG. 3 is a block diagram of a conversation using the conventional approach, according to some embodiments. The block diagram 300 includes a conversation stream 302 that includes an initial part 308 and one or more comments 306. The comments 306 include three different comments, for example, a first comment that is a reply from a user, a second comment that is a reply from a support agent, and a third comment that is another reply from the user.

As shown in FIG. 3, a conversation (e.g., conversation stream 302) is made up of one or more parts, each part representing a message sent from an end user device 118 into the communication system 102, or from the communication system 102 to the end user device 118. When a computing device (e.g., a communication system 102, customer device 116, end user device 118 in FIG. 1, displays a conversation in a message inbox (e.g., email inbox), the initial part 208 is stored and retrieved very differently from the rest of the comments 306 in the conversation. The communication system 102 supports broadcasting messages to one or more different end user devices 118, and for these conversations the communication system 102 stores, in local memory or database (e.g., local or remote), an initial part 208 for a plurality (e.g., some or all) conversations 202. The communication system 102 configures the initial part 208 to support templated text, which is substituted with user specific information when it is displayed.

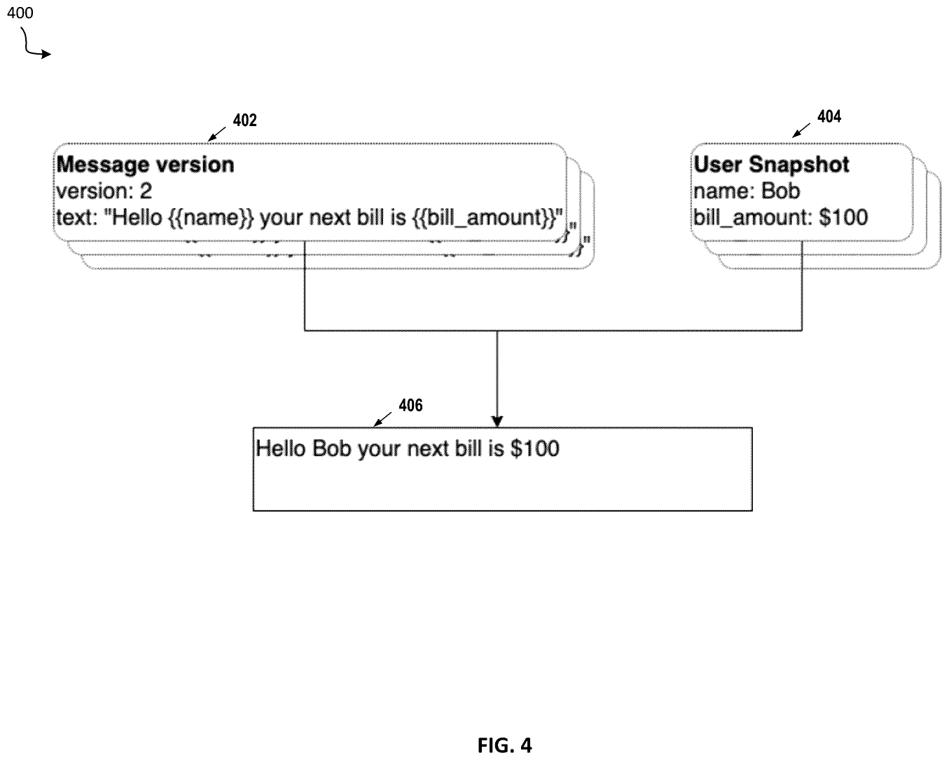

FIG. 4 is a block diagram for displaying a conversation using the conventional approach, according to some embodiments. The block diagram 400 shows how a message version 402 and a user snapshot 404 may be used to generate a combined message 406. That is, messages can also be versioned so, depending on when the message was sent, where different conversations may have a different version of the content. In order to display this conversation, the communication system 102 fetches the correct version and also any associated data (e.g., the user data at that point in time) that is specific to that fetched conversation in order to display the correct content to the user (e.g., end-user, customer, third party).

The benefits of the conventional approach for displaying a conversation are that for messages broadcast to many users, the communication system 102 only stores one record in a database (e.g., a data source), which makes it more efficient both in terms of storage and speed at the time of broadcast. However, this is expensive when it comes to displaying the conversation to the support agent in the message inbox as the communication system 102 pays the cost (e.g., additional delay, excesses use of computing and networking resources, write cost on the shared databases, etc.) of building the representation every time, and conversations are read many times more often than they are sent. This conventional approach also requires the communication system 102 to fetch data from two separate locations in order to build the whole conversation stream. For example, the communication system 102 fetches initial parts 308 from one location (e.g., a first remote storage), and the rest of the comments from an entirely different location (e.g., a second remote storage).

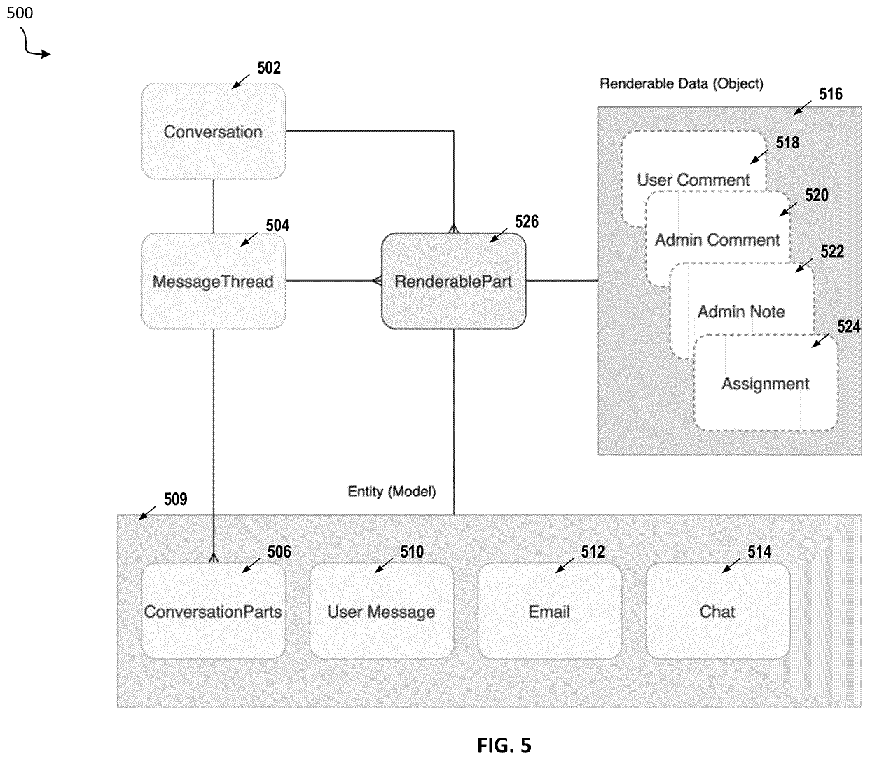

The embodiments of the present disclosure address the limitations of the conventional approach for displaying a conversation by introducing a new model to represent the renderable parts of a conversation. For example, FIG. 5 is a block diagram of an example model that generates initial parts of a conversation using a renderable part approach, according to some embodiments. The block diagram includes a conversation 502, a message thread 504, and an entity model 509 (e.g., initiator model 209 in FIG. 2). The entity model 509 includes a conversation parts 506, a user message 510, an email message 512, and a chat message 514. The block diagram includes a renderable data object 516 associated with a renderable part 526 (shown in FIG. 5 as, “RenderablePart”). The renderable data object 516 includes one or more user comments 518, one or more admin comments 520, one or more admin notes 522, and one or more assignments 524. The renderable data object 516 may execute on any of the communication system 102, the customer device 116, and/or the end user device 118.

The renderable parts 526 represents the renderable parts of the conversation 502. The communication system 102 records the renderable parts 526 alongside conversation parts 506 and message threads 504, and would not change any of the business logic that consumes and uses the conversation parts 506.

The renderable parts 526 (which is a model) has a direct association to the conversation 502, and an optional relationship with the message thread 504. The renderable parts 526 also has a relationship to the entity in the system that it represents. In some embodiments, this is a very common pattern in the Matching System and uses a combination of EntityType and EntityID to infer the correct model. For example, the entity_id, entity_type pair could point at a user message 510, a conversation part 506, an outbound email message 512, etc.

Most importantly, each renderable part 526 includes an embedded renderable data object 516, which the communication system 102 configures as a real object (instead of a plain hash) that includes the data for rendering (e.g., displaying) the renderable part 526 in a user interface (UI). The data contained within this renderable data object 516 is completely dependent on the type of part, for example, the renderable data for an assignment 524 might simply capture assigned_from_id and assigned_to_id, whereas the renderable data for a user message 510 might contain user_id and blocks. As long as the communication system 102 knows how to save and load these objects from the database, the communication system 102 can store any manner of renderable data. This gives the communication system 102 the flexibility to represent all the disparate types of parts that are possible, while giving the communication system 102 a structured system that makes it easy to return this data straight to the UI.

To start with, the communication system 102 records (in memory or a database) a renderable part 526 any time the communication system 102 creates a conversation part 506 (e.g., user comments 518, assignments 524, state changes, etc.), or a message thread 504 (e.g., outbound emails etc.). The communication system 102 records a renderable part 526 when creating a conversation 502 so that the end user conversation view could also be powered by renderable parts.

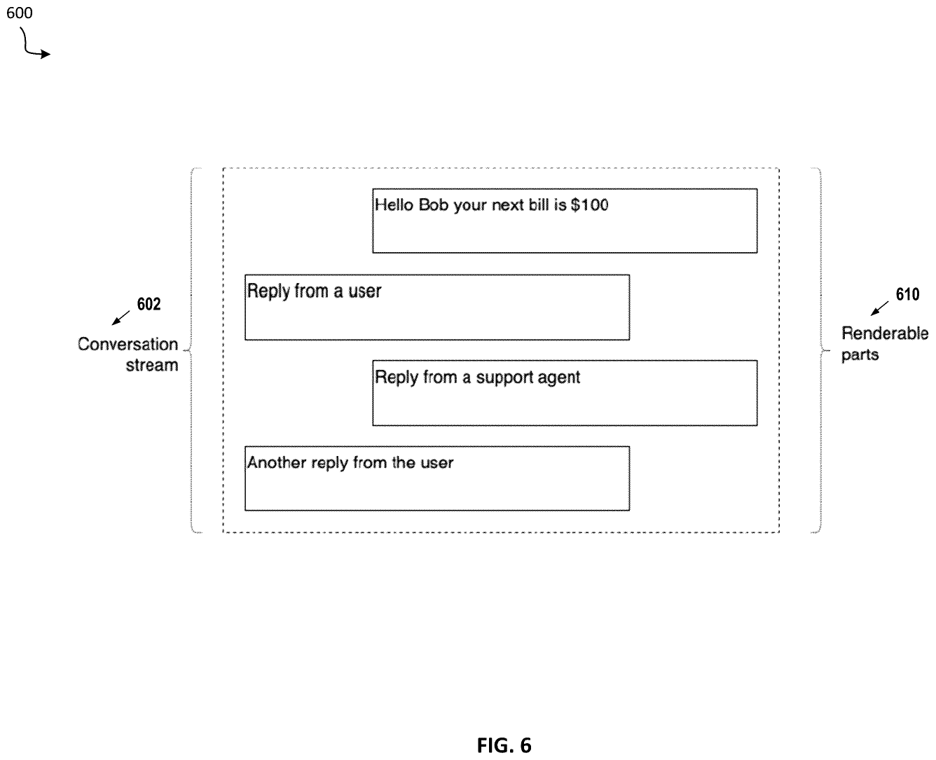

In other words, the embodiments of the present disclosure provide a database schema for “renderable parts” which contain all the parts for a conversation and don't treat initial parts any differently than any other part of the conversation. For example, FIG. 6 is a block diagram of a conversation using the renderable part approach, according to some embodiments. The block diagram 600 includes a conversation stream 602 that includes renderable parts 610. The renderable parts 610 include the initial part 308 in FIG. 3 and the one or more comments 306 in FIG. 3.

A database schema defines how data is organized within a relational database; this is inclusive of logical constraints such as, table names, fields, data types, and the relationships between these entities. That is, a database schema is considered the “blueprint” of a database which describes how the data may relate to other tables or other data models. A database schema may be, for example, a table. At a particular moment, a database schema may either include data (e.g., conversations, renderable data) or have no data.

The communication system 102 stores the renderable parts 610 alongside the existing data, so it is purely additive and other parts of the system need not be aware of the changes. This means that the communication system 102 can fetch the contents of a single conversation more efficiently (e.g., less delay, less resource wastage, less cost, etc.) as the communication system 102 no longer needs to fetch the initial part separately to the rest of the conversation, and any templated data from the initial part is stored as it needs to be sent so it does not require any additional work to be displayed.

Thus, in some embodiments, rendering a conversation using the conventional approach includes fetching a version of a message for a conversation, fetching data (user data) for a user, combining the message with the user data to fill in templated fields, fetching one or more comments for the conversation, combining an initial part with the rest of the comments, and sending the data. However, in some embodiments, rendering a conversation using the renderable parts approach includes, fetching a plurality (some or all) renderable parts for a conversation, and sending the data (user data).

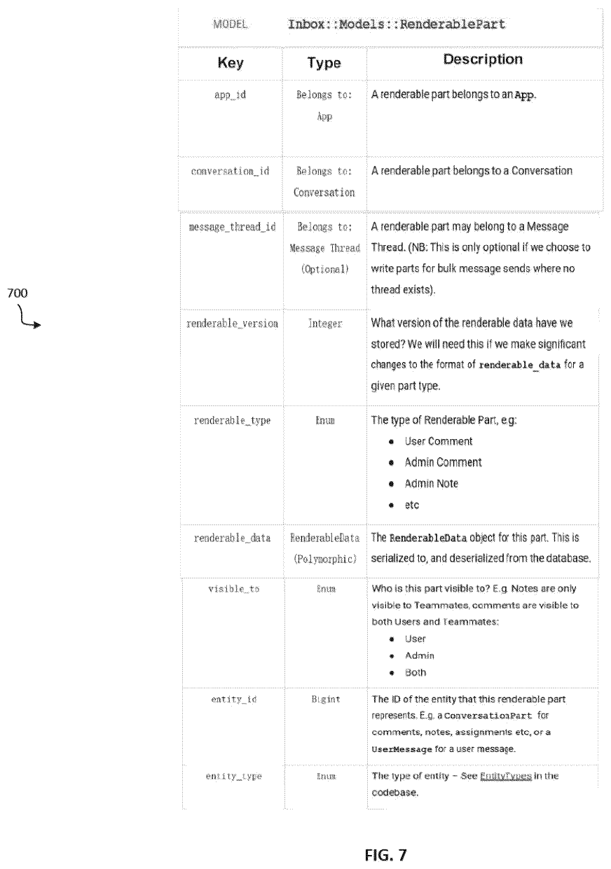

FIG. 7 is a table depicting a RenderablePart data model for the renderable part approach, according to some embodiments. The table 700 shows a plurality of keys, each associated with a type and a description.

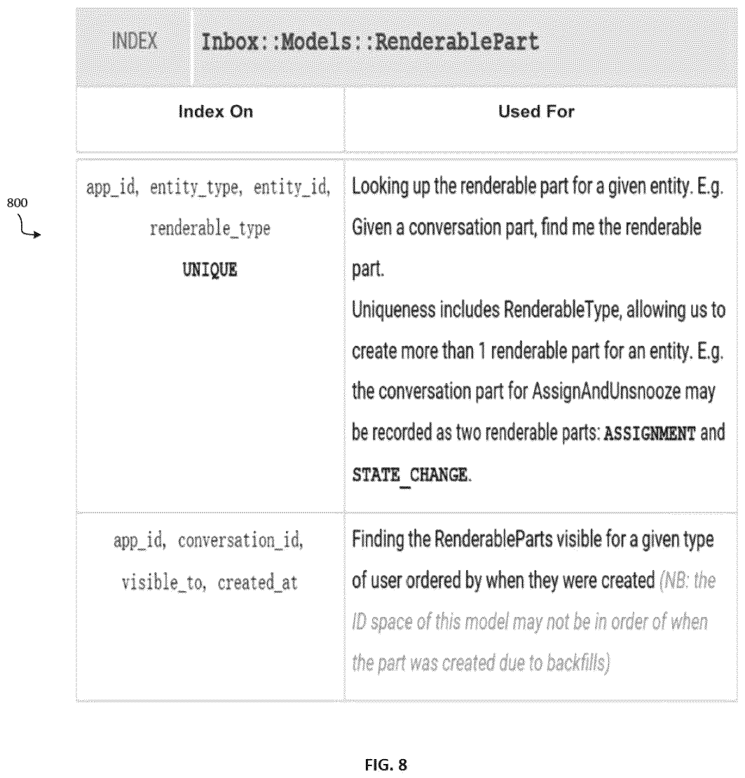

FIG. 8 is a table depicting a RenderablePart data model for the renderable part approach, according to some embodiments. The table 800 explains how the communication system 102 may use one or more IndexOn values.

### 3. Last Part References

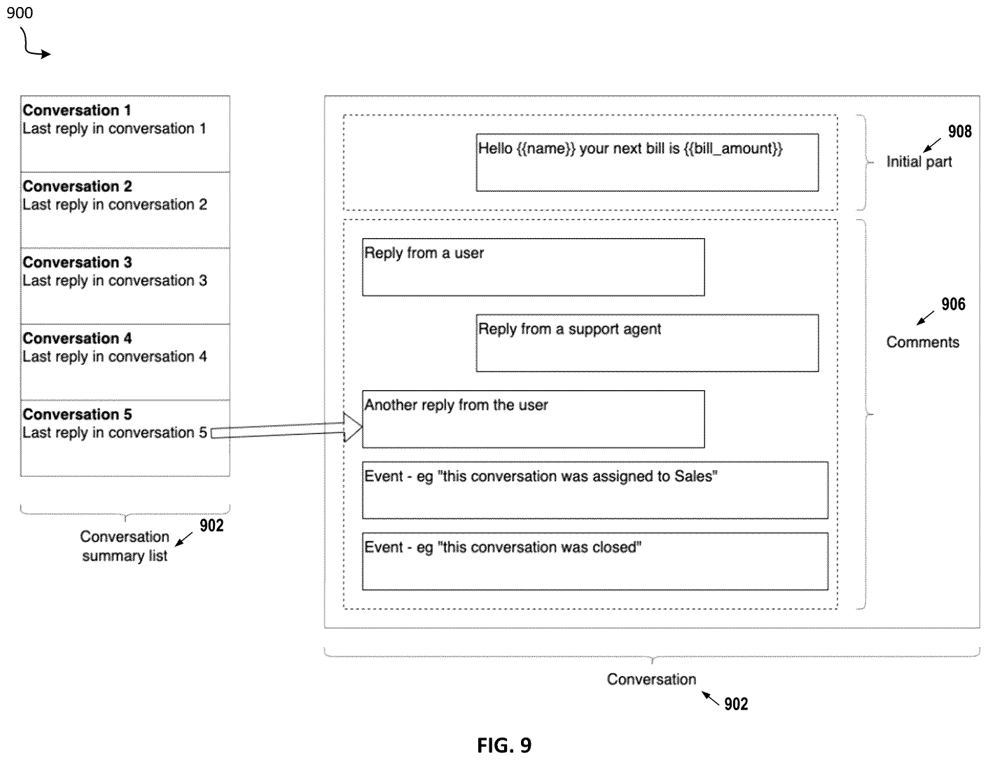

FIG. 9 is a block diagram of displaying a conversation with a conversation summary list using a conventional approach, according to some embodiments. The block diagram 900 includes a conversation 902 that includes an initial part 908 and one or more comments 906. The comments 906 include five different comments, for example, a first comment that is a reply from a user, a second comment that is a reply from a support agent, a third comment that is another reply from the user, a fourth comment that is related to an event, and a fifth comment that is related to another event. The block diagram 900 also includes a conversation summary list 902 that includes a plurality of conversations (e.g., conversations 1-5).

As shown in FIG. 9, the communication system 102 displays, in a message inbox (e.g., email inbox), a conversation summary list 902 that a support agent can use to get an overview of a conversation without having to look at the full conversation to see what is happening. The conversation summary list includes the last “relevant” part of the conversation, such as the last reply excluding any activity events.

When using the conventional approach to display a conversation with a conversation summary list, the communication system 102 fetches all the comments for a conversation, including the initial part because there may not have been any subsequent replies yet, and finds (e.g., search and identify) the last relevant comment to use in the summary.

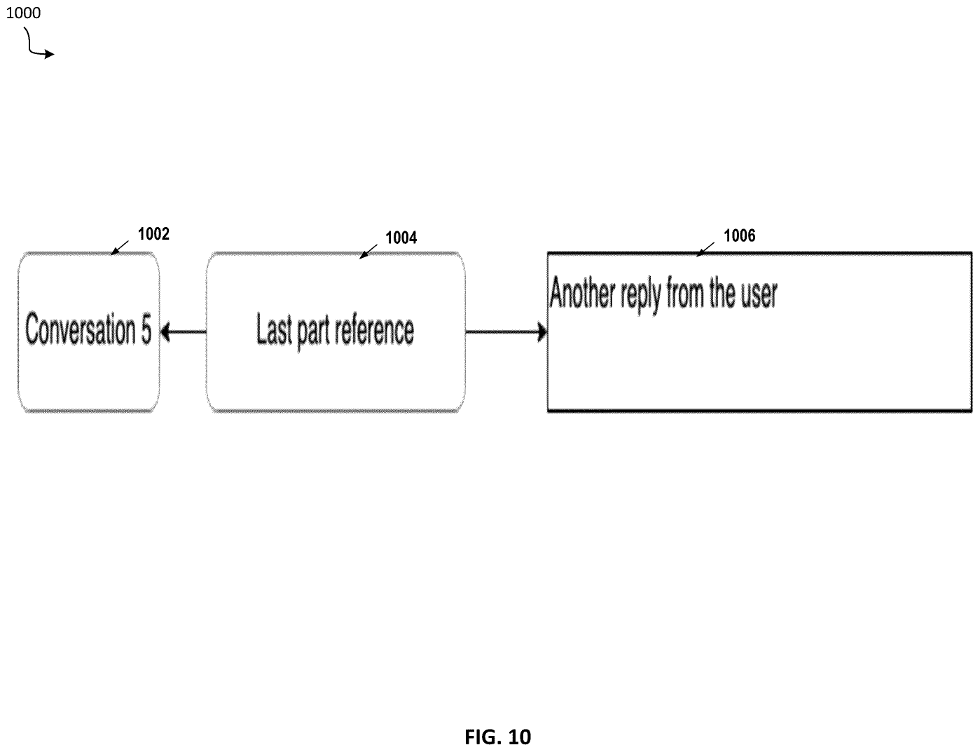

Alternatively, the communication system 102 may use a last part reference approach instead. For example, FIG. 10 is a block diagram of displaying a conversation with a conversation summary list using a last part reference approach. The block diagram 1000 includes a part 1002 (e.g., conversation 5 in FIG. 9), a last part reference 1004, and part 1006 (e.g., another reply from the user). Given a list of conversation identifiers (IDs) to render summaries for, or cards for in the UI, the communication system 102 needs an efficient way to pick out which renderable part to show in the summary representing the “last message.” This is often not the last renderable part for a conversation. For example, a conversation that has an admin comment (e.g., admin comment 520 in FIG. 5) followed by being closed, the communication system 102 wants to show the last admin comment rather than the “closed by Alice 5m ago” part. Therefore, to implement the last part reference approach, the communication system 102 may use a simple join table to record which part is the “last” part for various different rendering locations. The communication system may insert the references upon creation of a relevant renderable part.

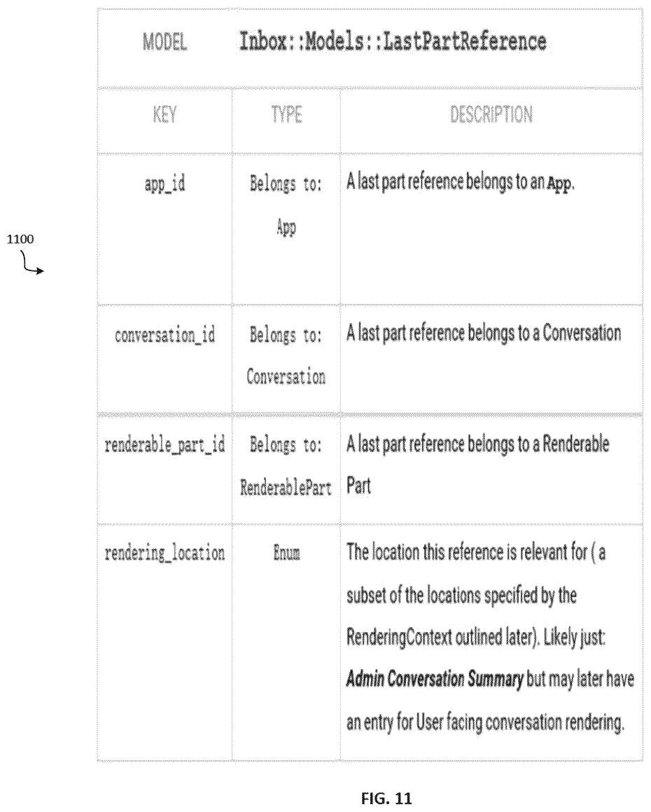

FIG. 11 is a table depicting a LastPartReference data model for the last part reference approach, according to some embodiments. The table 1100 shows a plurality of keys, each associated with a type and a description.

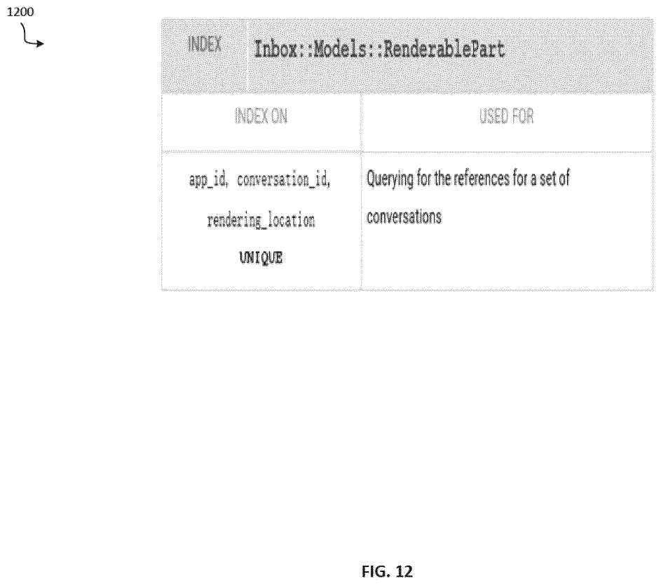

FIG. 12 is a table depicting a RenderablePart data model for the last part reference approach, according to some embodiments. The table 1100 explains how the communication system 102 may use one or more IndexOn values.

### 4. Data Loading

To display a conversation using the conventional approach, the communication system 102 fetches the data for all the individual replies and from a variety of different data sources that store the data. For example, each reply includes the user/admin information of the sender, any uploads attached, and any tags. A tag (or conversation part tag) refers to the data that is not directly referenced in the JSON, which is saved as part of the RenderableData object. A tag is dynamic data that is added after the RenderablePart would have been created. A tag is rendered in the UI. Now, different types of replies might use different data, for example, admin replies may not have tags but user replies can have tags. These are all stored in different database tables, sometimes in entirely different databases, and communication system 102 must issue queries to fetch the data.

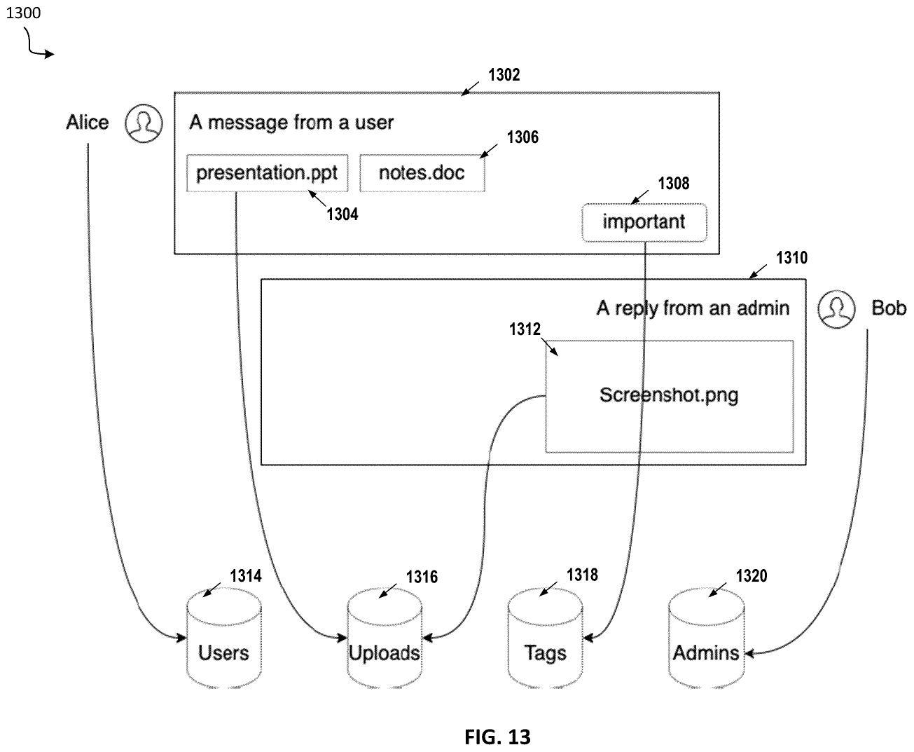

For example, FIG. 13 is a block diagram of data loading to display a conversation using a conventional approach, according to some embodiments. The block diagram 1300 includes a message 1302 from a user (Alice) that includes a first attachment 1304 (e.g., presentation.ppt) and a second attachment (e.g., notes.doc). The block diagram 1300 also includes a reply 1310 from an admin (Bob) that includes a first attachment 1312 (e.g., screenshot.png). The block diagram 1300 also includes a user database 1314, an uploads database 1316, a tags database 1318, and an admins database 1320.

When using the conventional approach, the communication system 102 fetches the data from the appropriate database (e.g., a user database 1314, an uploads database 1316, a tags database 1318, and an admins database 1320) and serialize each of the parts individually. For example, if the communication system 102 determines that there are 10 replies with identifier (IDs) of 1 through 10, then the communication system 102 may perform the following procedure: fetch the user for reply #1, fetch the uploads for reply #1, fetch the tags for reply #1, fetch the admin for reply #2, fetch the uploads for reply #2, fetch the user for reply #3, fetch the uploads for reply #3, fetch the tags for reply #3, and so on for all 10 replies.

If the communication system 102 determines that there are 10 replies, and each reply has data in 3 different data sources then, then the communication system 102 will issue 30 database queries one after the other in order to fetch the required data, including the query issued to fetch the list of replies. Some of these queries, in some embodiments, may be identical, as multiple replies will fetch data for the same user or admin. This is known as the N+1 problem, as the number of items grows so does the number of queries issued.

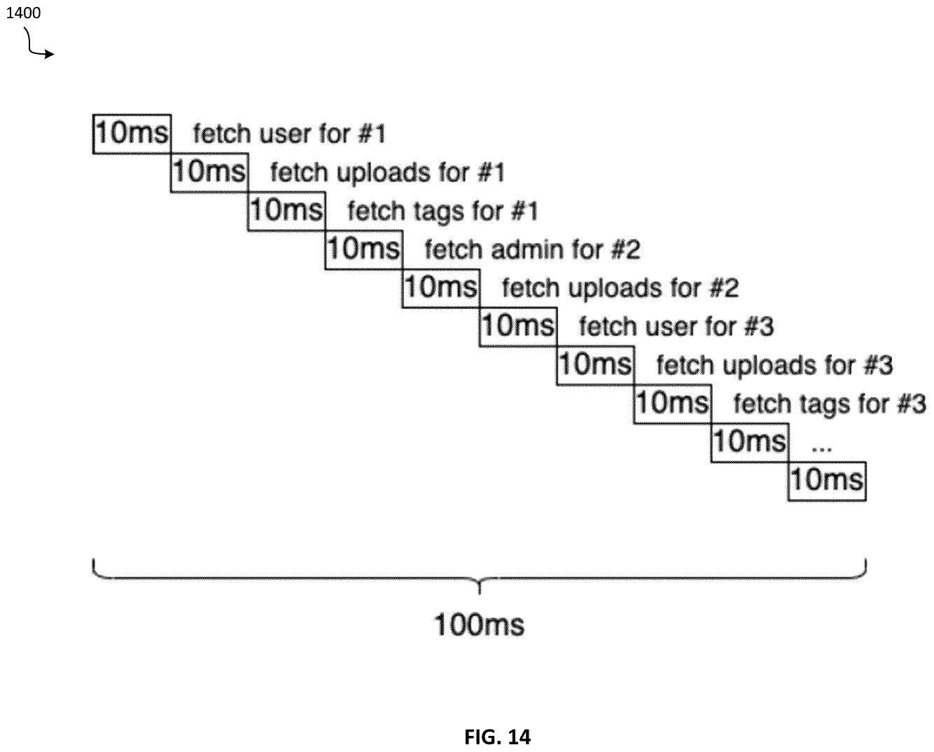

Conversations can have hundreds or even thousands of replies, so the number of possible queries can be vast. These queries are also issued synchronously, one after the other, so if, for example, there are 10 queries and each query takes 10 ms then the communication system 102 would spend 100 ms (e.g., 10 ms×10 queries) communicating to the database. For example, FIG. 14 is a block diagram of the latency to display a conversation using a conventional approach, according to some embodiments.

Alternatively, the communication system 102 may use a bulk fetch approach. That is, instead of each individual reply fetching its own data, the communication system 102 may use a data loader for each type of data, which knows how to fetch data for multiple items at a time. Each reply defines the types of data it needs to fetch, such as tags or uploads, and the data loaders then load the data for all replies at once. Each data loader is run (e.g., executed) in its own thread (e.g., of an operating system), so the communication system 102 can run these requests in parallel; thereby improving performance in two aspects. First, the communication system 102 can perform fewer queries. Second, the communication system 102 can perform the queries in parallel.

For example, given 4 data loaders (e.g., for tags, uploads, admins, and users), the communication system 102 would perform just 4 queries no matter how many replies for which the communication system 102 is fetching data for. The procedure would be as follows: fetch tags for all replies (#1 . . . #10), fetch uploads for all replies (#1 . . . #10), fetch admins for all replies (#1 . . . #10), and fetch users for all replies (#1 . . . #10).

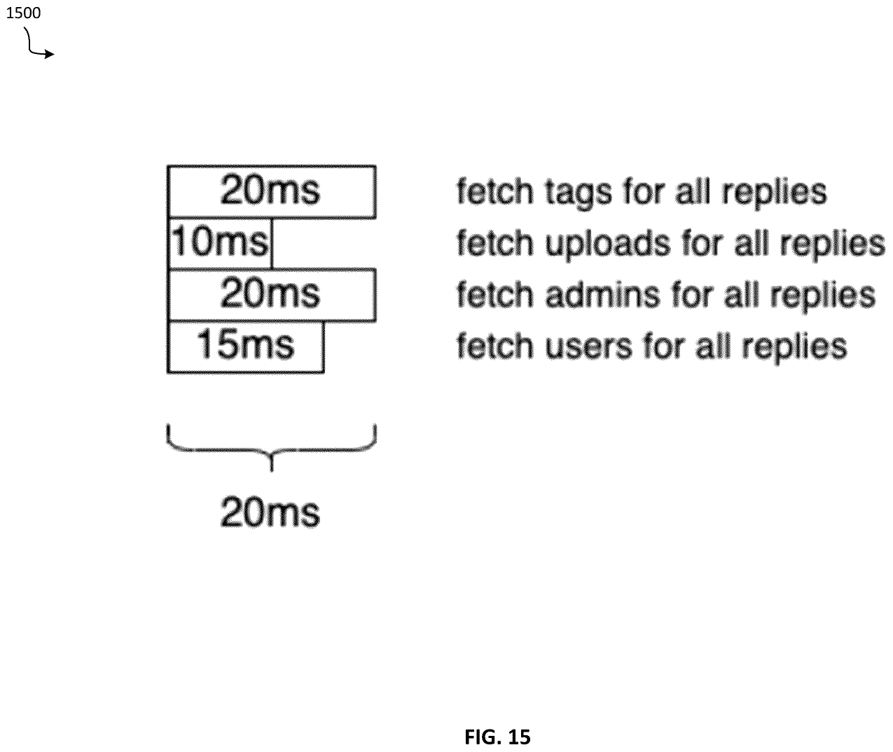

Because these queries are in parallel, then instead of taking the sum of all durations to fetch the data, the cost is the duration of the slowest query. For example, if these queries took 20 ms, 10 ms, 20 ms & 15 ms, then the total duration would be just 20 ms as opposed to 65 ms if they were executed synchronously. This is shown in FIG. 15, which is a block diagram of the latency to display a conversation using a bulk fetch approach, according to some embodiments.

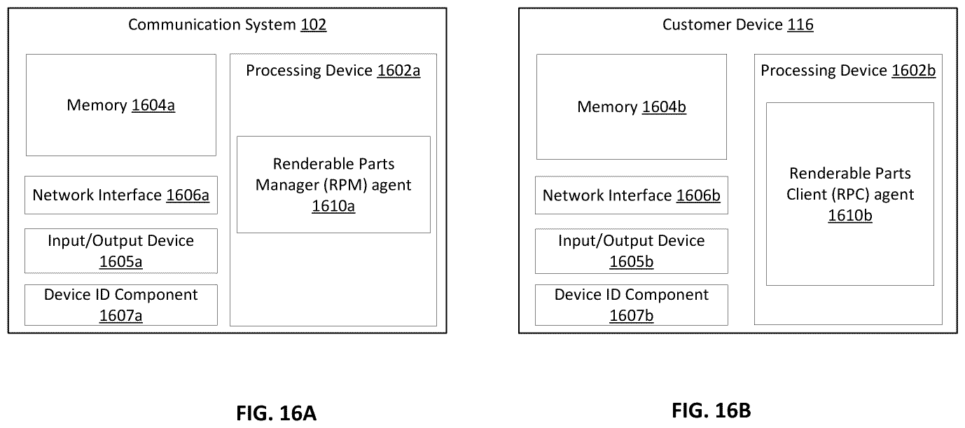

FIG. 16A is a block diagram depicting an example of the communication system 102 in FIG. 1, according to some embodiments. While various devices, interfaces, and logic with particular functionality are shown, it should be understood that the communication system 102 includes any number of devices and/or components, interfaces, and logic for facilitating the functions described herein. For example, the activities of multiple devices may be combined as a single device and implemented on a same processing device (e.g., processing device 1602a), as additional devices and/or components with additional functionality are included.

The communication system 102 includes a processing device 1602a (e.g., general purpose processor, a PLD, etc.), which may be composed of one or more processors, and a memory 1604a (e.g., synchronous dynamic random-access memory (DRAM), read-only memory (ROM)), which may communicate with each other via a bus (not shown).

The processing device 1602a may be provided by one or more general-purpose processing devices such as a microprocessor, central processing unit, or the like. In some embodiments, processing device 1602a may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 1602a may comprise one or more special-purpose processing devices such as an application specific integrated circuit (ASIC), a field programmable gate array (FPGA), a digital signal processor (DSP), network processor, or the like. The processing device 1602a may be configured to execute the operations described herein, in accordance with one or more aspects of the present disclosure, for performing the operations and steps discussed herein.

The memory 1604a (e.g., Random Access Memory (RAM), Read-Only Memory (ROM), Non-volatile RAM (NVRAM), Flash Memory, hard disk storage, optical media, etc.) of processing device 1602a stores data and/or computer instructions/code for facilitating at least some of the various processes described herein. The memory 1604a includes tangible, non-transient volatile memory, or non-volatile memory. The memory 1604a stores programming logic (e.g., instructions/code) that, when executed by the processing device 1602a, controls the operations of the communication system 102. In some embodiments, the processing device 1602a and the memory 1604a form various processing devices and/or circuits described with respect to the communication system 102. The instructions include code from any suitable computer programming language such as, but not limited to, C, C++, C #, Java, JavaScript, VBScript, Perl, HTML, XML, Python, TCL, and Basic.

The processing device 1602a may execute a renderable parts manager (RPM) agent 1610a that may be configured to generate a database schema (e.g., a table) to store an initial part of a conversation and a plurality of replies of the conversation, the initial part is sourced from a data source and the plurality of replies of the conversation is sourced from a plurality of other data sources. The RPM agent 1610a that may be configured to receive, from a client device, a request to provide the conversation. The RPM agent 1610a that may be configured to fetch the database schema from a single data source. The RPM agent 1610a that may be configured to transmit the database schema to the client device for displaying, in an application executing on the client device, the initial part of the conversation and the plurality of replies of the conversation.

In some embodiments, a first reply of the plurality of replies of the conversation indicates a first set of data types and a second reply of the plurality of replies of the conversation indicates a second set of data types

The RPM agent 1610a that may be configured to generate based on the first set of data types, a first data loader. The RPM agent 1610a that may be configured to generate, based on the second set of data types, a second data loader. The RPM agent 1610a that may be configured to fetch, using the first data loader, a first set of data associated with the first set of data types from a first set of data sources. The RPM agent 1610a that may be configured to fetch, using the second data loader, a second set of data associated with the second set of data types from a second set of data sources.

The RPM agent 1610a that may be configured to execute the first data loader in a first thread of an operating system and the second data loader in a second thread of the operating system to at least one of fetch the first set of data and the second set of data in parallel or reduce a number of queries to fetch the first set of data and the second set of data.

The RPM agent 1610a that may be configured to identify a reply in the conversation as being a last reply. The RPM agent 1610a that may be configured to generate a second database schema to indicate the reply as being the last reply.

The RPM agent 1610a that may be configured to fetch, using the second database scheme, the initial part of the conversation and the plurality of replies of the conversation using a single query.

The RPM agent 1610a that may be configured to detect that the reply is no longer the last reply in the conversation. The RPM agent 1610a that may be configured to update the second database schema to indicate a different reply as being the last reply in the conversation.

The RPM agent 1610a that may be configured to generate, by the processing device, the database schema prior to receiving, from the client device, the request to provide the conversation. In some embodiments, the plurality of replies of the conversation comprises sender information, an attachment, and a conversation tag.

The communication system 102 includes a network interface 1606a configured to establish a communication session with a computing device for sending and receiving data over the communications network 108 to the computing device. Accordingly, the network interface 1606A includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some embodiments, the communication system 102 includes a plurality of network interfaces 1606a of different types, allowing for connections to a variety of networks, such as local area networks (public or private) or wide area networks including the Internet, via different sub-networks.

The communication system 102 includes an input/output device 1605a configured to receive user input from and provide information to a user. In this regard, the input/output device 1605a is structured to exchange data, communications, instructions, etc. with an input/output component of the communication system 102. Accordingly, input/output device 1605a may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). The one or more user interfaces may be internal to the housing of communication system 102, such as a built-in display, touch screen, microphone, etc., or external to the housing of communication system 102, such as a monitor connected to communication system 102, a speaker connected to communication system 102, etc., according to various embodiments. In some embodiments, the communication system 102 includes communication circuitry for facilitating the exchange of data, values, messages, and the like between the input/output device 1605a and the components of the communication system 102. In some embodiments, the input/output device 1605a includes machine-readable media for facilitating the exchange of information between the input/output device 1605a and the components of the communication system 102. In still another embodiment, the input/output device 1605a includes any combination of hardware components (e.g., a touchscreen), communication circuitry, and machine-readable media.

The communication system 102 includes a device identification component 1607a (shown in FIG. 14A as device ID component 1607a) configured to generate and/or manage a device identifier associated with the communication system 102. The device identifier may include any type and form of identification used to distinguish the communication system 102 from other computing devices. In some embodiments, to preserve privacy, the device identifier may be cryptographically generated, encrypted, or otherwise obfuscated by any device and/or component of communication system 102. In some embodiments, the communication system 102 may include the device identifier in any communication (e.g., a message that it transmits to the customer device 116, etc.) that the communication system 102 sends to a computing device.

The communication system 102 includes a bus (not shown), such as an address/data bus or other communication mechanism for communicating information, which interconnects the devices and/or components of communication system 102, such as processing device 1602a, network interface 1606a, input/output device 1605a, and device ID component 1607a.

In some embodiments, some or all of the devices and/or components of communication system 102 may be implemented with the processing device 1602a. For example, the communication system 102 may be implemented as a software application stored within the memory 1604a and executed by the processing device 1602a. Accordingly, such embodiment can be implemented with minimal or no additional hardware costs. In some embodiments, any of these above-recited devices and/or components rely on dedicated hardware specifically configured for performing operations of the devices and/or components.

FIG. 16B is a block diagram depicting an example of a customer device in FIG. 1 (or end user device 118 in FIG. 1 or third party system 120 in FIG. 1), according to some embodiments. While various devices, interfaces, and logic with particular functionality are shown, it should be understood that the customer device 116 includes any number of devices and/or components, interfaces, and logic for facilitating the functions described herein. For example, the activities of multiple devices may be combined as a single device and implemented on a same processing device (e.g., processing device 1602b), as additional devices and/or components with additional functionality are included.

The customer device 116 includes a processing device 1602b (e.g., general purpose processor, a PLD, etc.), which may be composed of one or more processors, and a memory 1604b (e.g., synchronous dynamic random-access memory (DRAM), read-only memory (ROM)), which may communicate with each other via a bus (not shown). The processing device 1602b includes identical or nearly identical functionality as processing device 1602a in FIG. 16a, but with respect to devices and/or components of the customer device 116 instead of devices and/or components of the communication system 102.

The memory 1604b of processing device 1602b stores data and/or computer instructions/code for facilitating at least some of the various processes described herein. The memory 1604b includes identical or nearly identical functionality as memory 1604a in FIG. 16A, but with respect to devices and/or components of the customer device 116 instead of devices and/or components of the communication system 102.

The processing device 1602b may be configured to include and/or execute a renderable parts client (RPC) agent 1610b that is displayed on a computer screen of the communication system 102. In some embodiments, the RPC agent 1610b may be configured to receive an updated banner message from the communication system 102. In some embodiments, the RPC agent 1610b may be configured to present the updated banner message on a display associated with the client device of the RPC agent 1610b.

The RPC agent 1610b may be configured to detect that a user of the client device interacted with a tracking link of the updated banner message. A user action may include, for example, hovering a mouser cursor of the client device over the link, clicking on the link with a mouse cursor or keyboard stroke, a voice command from the user that identifies the link, etc. In response to detecting the user interaction with the link, the RPC agent 1610b may send a message (sometimes referred as, user interaction message) to the communication system 102 to notify the communication system 102 that the user interacted with the link.

The customer device 116 includes a network interface 1606b configured to establish a communication session with a computing device for sending and receiving data over a network to the computing device. Accordingly, the network interface 1606b includes identical or nearly identical functionality as network interface 1606a in FIG. 16A, but with respect to devices and/or components of the customer device 116 instead of devices and/or components of the communication system 102.

The customer device 116 includes an input/output device 1605b configured to receive user input from and provide information to a user. In this regard, the input/output device 1605b is structured to exchange data, communications, instructions, etc. with an input/output component of the customer device 116. The input/output device 1605b includes identical or nearly identical functionality as input/output processor 1605a in FIG. 16A, but with respect to devices and/or components of the customer device 116 instead of devices and/or components of the communication system 102.

The customer device 116 includes a device identification component 1607b (shown in FIG. 16B as device ID component 1607b) configured to generate and/or manage a device identifier associated with the customer device 116. The device ID component 1607b includes identical or nearly identical functionality as device ID component 1607a in FIG. 16A, but with respect to devices and/or components of the customer device 116 instead of devices and/or components of the communication system 102.

The customer device 116 includes a bus (not shown), such as an address/data bus or other communication mechanism for communicating information, which interconnects the devices and/or components of the customer device 116, such as processing device 1602b, network interface 1606b, input/output device 1605b, and device ID component 1607b.

In some embodiments, some or all of the devices and/or components of customer device 116 may be implemented with the processing device 1602b. For example, the customer device 116 may be implemented as a software application stored within the memory 1604b and executed by the processing device 1602b. Accordingly, such embodiment can be implemented with minimal or no additional hardware costs. In some embodiments, any of these above-recited devices and/or components rely on dedicated hardware specifically configured for performing operations of the devices and/or components.

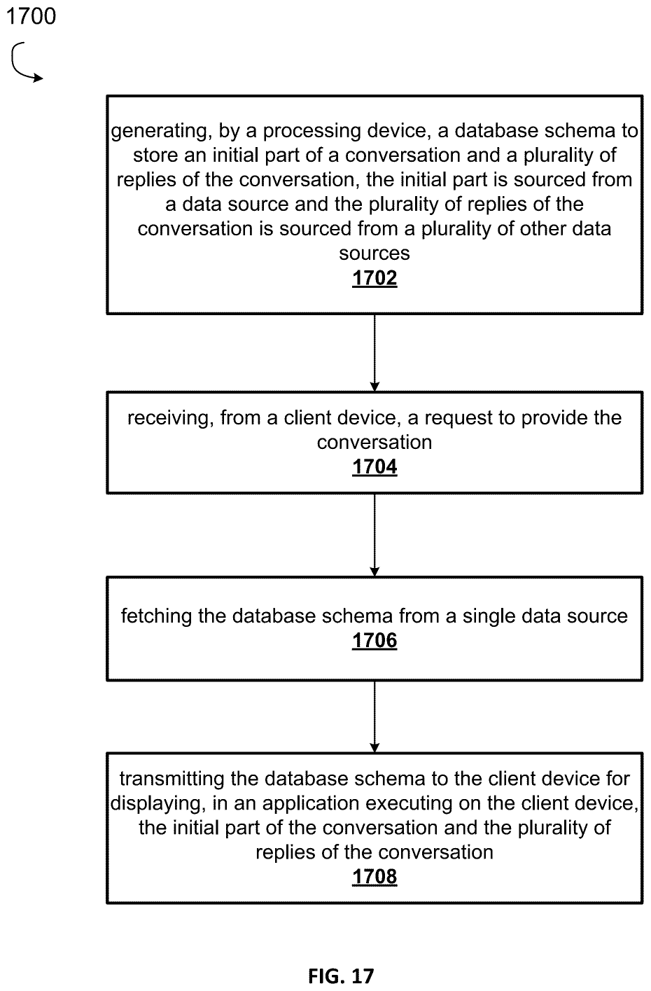

FIG. 17 is a flow diagram depicting a method of fetching renderable parts of content items in bulk, according to some embodiments. Method 1700 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, method 2100 may be performed by one or more communication systems, such as communication systems 102 in FIG. 1.

With reference to FIG. 17, method 1700 illustrates example functions used by various embodiments. Although specific function blocks (“blocks”) are disclosed in method 1700, such blocks are examples. That is, embodiments are well suited to performing various other blocks or variations of the blocks recited in method 1700. It is appreciated that the blocks in method 1700 may be performed in an order different than presented, and that not all of the blocks in method 1700 may be performed.

As shown in FIG. 17, the method 1700 includes the block 1702 generating, by a processing device, a database schema to store an initial part of a conversation and a plurality of replies of the conversation, the initial part is sourced from a data source and the plurality of replies of the conversation is sourced from a plurality of other data sources. The method 2100 includes the block 2104 of receiving, from a client device, a request to provide the conversation. The method 2100 includes the block 2106 of fetching the database schema from a single data source. The method 2100 includes the block 2108 of transmitting the database schema to the client device for displaying, in an application executing on the client device, the initial part of the conversation and the plurality of replies of the conversation.

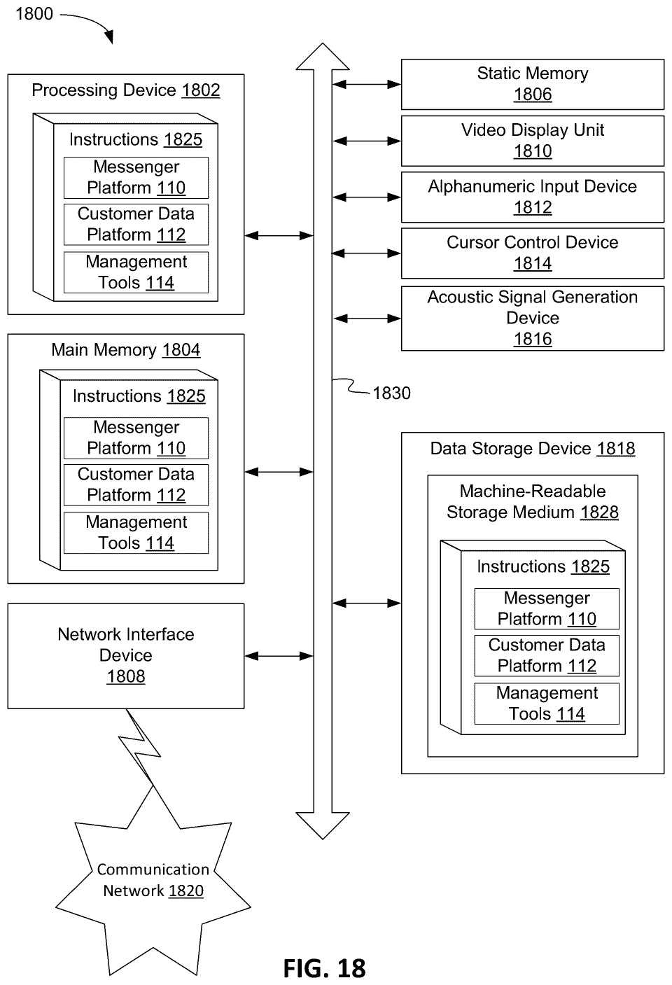

FIG. 18 is a block diagram of an example computing device 1800 that may perform one or more of the operations described herein, in accordance with some embodiments. Computing device 1800 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 1800 may include a processing device (e.g., a general-purpose processor, a PLD, etc.) 2002, a main memory 2004 (e.g., synchronous dynamic random-access memory (DRAM), read-only memory (ROM)), a static memory 1806 (e.g., flash memory and a data storage device 1818), which may communicate with each other via a bus 1830.

Processing device 1802 may be provided by one or more general-purpose processing devices such as a microprocessor, central processing unit, or the like. In an illustrative example, processing device 1802 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 1802 may comprise one or more special-purpose processing devices such as an application specific integrated circuit (ASIC), a field programmable gate array (FPGA), a digital signal processor (DSP), network processor, or the like. The processing device 1802 may be configured to execute the operations described herein, in accordance with one or more aspects of the present disclosure, for performing the operations and steps discussed herein.

Computing device 1800 may further include a network interface device 1808 which may communicate with a communication network 1820. The computing device 1800 also may include a video display unit 1810 (e.g., a liquid crystal display (LCD) or a cathode ray tube (CRT)), an alphanumeric input device 1812 (e.g., a keyboard), a cursor control device 1814 (e.g., a mouse) and an acoustic signal generation device 1816 (e.g., a speaker). In one embodiment, video display unit 1810, alphanumeric input device 1812, and cursor control device 1814 may be combined into a single component or device (e.g., an LCD touch screen).

Data storage device 1818 may include a computer-readable storage medium 1828 on which may be stored one or more sets of instructions 1825 that may include instructions for one or more components (e.g., messenger platform 110, the customer data platform 112, and the management tools 114) for carrying out the operations described herein, in accordance with one or more aspects of the present disclosure. Instructions 1825 may also reside, completely or at least partially, within main memory 1804 and/or within processing device 1802 during execution thereof by computing device 1800, main memory 1804 and processing device 1802 also constituting computer-readable media. The instructions 1825 may further be transmitted or received over a communication network 1820 via network interface device 1808.

While computer-readable storage medium 1828 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “generating,” “receiving,” “fetching,” “transmitting,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein may relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. The terms “comprises”, “comprising”, “includes”, and/or “including”, when used herein, may specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

In some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present embodiments to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present embodiments are not to be limited to the details given herein, but may be modified within the scope and equivalents of the appended claims.

What is claimed is:

1. A method comprising:
generating, by a processing device, a database schema to store an initial part of a conversation and a plurality of replies of the conversation, the initial part is sourced from a data source and the plurality of replies of the conversation is sourced from a plurality of other data sources;
receiving, from a client device, a request to provide the conversation;
fetching the database schema from a single data source; and
transmitting the database schema to the client device for displaying, in an application executing on the client device, the initial part of the conversation and the plurality of replies of the conversation.

2. The method of claim 1, wherein a first reply of the plurality of replies of the conversation indicates a first set of data types and a second reply of the plurality of replies of the conversation indicates a second set of data types, and further comprising:
generating, based on the first set of data types, a first data loader;
generating, based on the second set of data types, a second data loader;
fetching, using the first data loader, a first set of data associated with the first set of data types from a first set of data sources; and
fetching, using the second data loader, a second set of data associated with the second set of data types from a second set of data sources.

3. The method of claim 2, further comprising:
executing the first data loader in a first thread of an operating system and the second data loader in a second thread of the operating system to at least one of fetch the first set of data and the second set of data in parallel or reduce a number of queries to fetch the first set of data and the second set of data.

4. The method of claim 1, further comprising:
identifying a reply in the conversation as being a last reply; and
generating a second database schema to indicate the reply as being the last reply.

5. The method of claim 4, further comprising:
fetching, using the second database schema, the initial part of the conversation and the plurality of replies of the conversation using a single query.

6. The method of claim 4, further comprising:
detecting that the reply is no longer the last reply in the conversation; and
updating the second database schema to indicate a different reply as being the last reply in the conversation.

7. The method of claim 1, wherein generating, by the processing device, the database schema is prior to receiving, from the client device, the request to provide the conversation, and wherein the plurality of replies of the conversation comprises sender information, an attachment, and a conversation tag.

8. A system comprising:
a memory; and
a processing device, operatively coupled to the memory, to:
generate a database schema to store an initial part of a conversation and a plurality of replies of the conversation, the initial part is sourced from a data source and the plurality of replies of the conversation is sourced from a plurality of other data sources;
receive, from a client device, a request to provide the conversation;
fetch the database schema from a single data source; and
transmit the database schema to the client device for displaying, in an application executing on the client device, the initial part of the conversation and the plurality of replies of the conversation.

9. The system of claim 8, wherein a first reply of the plurality of replies of the conversation indicates a first set of data types and a second reply of the plurality of replies of the conversation indicates a second set of data types, and wherein the processing device further to:
generate, based on the first set of data types, a first data loader;
generate, based on the second set of data types, a second data loader;
fetch, using the first data loader, a first set of data associated with the first set of data types from a first set of data sources; and
fetch, using the second data loader, a second set of data associated with the second set of data types from a second set of data sources.

10. The system of claim 9, wherein the processing device further to:
execute the first data loader in a first thread of an operating system and the second data loader in a second thread of the operating system to at least one of fetch the first set of data and the second set of data in parallel or reduce a number of queries to fetch the first set of data and the second set of data.

11. The system of claim 8, wherein the processing device further to:
identify a reply in the conversation as being a last reply; and
generate a second database schema to indicate the reply as being the last reply.

12. The system of claim 11, wherein the processing device further to:
fetch, using the second database schema, the initial part of the conversation and the plurality of replies of the conversation using a single query.

13. The system of claim 11, wherein the processing device further to:
detect that the reply is no longer the last reply in the conversation; and
update the second database schema to indicate a different reply as being the last reply in the conversation.

14. The system of claim 8, wherein to generate the database schema is prior to receiving, from the client device, the request to provide the conversation, and wherein the plurality of replies of the conversation comprises sender information, an attachment, and a conversation tag.

15. A non-transitory computer-readable medium storing instructions that, when execute by a processing device, cause the processing device to:
generate, using the processing device, a database schema to store an initial part of a conversation and a plurality of replies of the conversation, the initial part is sourced from a data source and the plurality of replies of the conversation is sourced from a plurality of other data sources;
receive, from a client device, a request to provide the conversation;
fetch the database schema from a single data source; and
transmit the database schema to the client device for displaying, in an application executing on the client device, the initial part of the conversation and the plurality of replies of the conversation.

16. The non-transitory computer-readable medium of claim 15, wherein a first reply of the plurality of replies of the conversation indicates a first set of data types and a second reply of the plurality of replies of the conversation indicates a second set of data types, and the processing device further to:
generate, based on the first set of data types, a first data loader;
generate, based on the second set of data types, a second data loader;
fetch, using the first data loader, a first set of data associated with the first set of data types from a first set of data sources; and
fetch, using the second data loader, a second set of data associated with the second set of data types from a second set of data sources.

17. The non-transitory computer-readable medium of claim 16, wherein the processing device further to:
execute the first data loader in a first thread of an operating system and the second data loader in a second thread of the operating system to at least one of fetch the first set of data and the second set of data in parallel or reduce a number of queries to fetch the first set of data and the second set of data.

18. The non-transitory computer-readable medium of claim 15, wherein the processing device further to:
identify a reply in the conversation as being a last reply; and
generate a second database schema to indicate the reply as being the last reply.

19. The non-transitory computer-readable medium of claim 18, wherein the processing device further to:
fetch, using the second database schema, the initial part of the conversation and the plurality of replies of the conversation using a single query.

20. The non-transitory computer-readable medium of claim 18, wherein the processing device further to:
detect that the reply is no longer the last reply in the conversation; and
update the second database schema to indicate a different reply as being the last reply in the conversation.
